(19) United States
(12) Patent Application Publication
(10) Pub. No.: US 2025/0094906 A1
(43) Pub. Date: Mar. 20, 2025

(54) METHODS AND SYSTEMS FOR AGRICULTURAL MOISTURE MANAGEMENT

(71) Applicant: Dark Horse Ag Ventures Ltd., Saskatoon (CA)

(72) Inventors: Tyler Lefley, Saskatoon (CA); Garrett Fraser, Rocky View Country (CA)

(21) Appl. No.: 18/467,100

(22) Filed: Sep. 14, 2023

(51) Int. Cl. G06Q 10/0637

(52) U.S. Cl. CPC G06Q 10/0637

(57) ABSTRACT

Computer-implemented methods and systems for soil moisture management. The method comprises obtaining a plurality of seasonal yield datasets for a field. The seasonal yield datasets contain plurality of point yields corresponding to a plurality of locations of the field. The seasonal yield datasets are normalized. The method includes obtaining moisture data for the field and determining a moisture content value for each location in the field based on the normalized plurality of seasonal yield datasets and the moisture data. A productivity map for the field is then generated.

### TECHNICAL FIELD

The disclosed exemplary embodiments relate to methods and systems for agricultural moisture management.

### BACKGROUND

One aspect of farm management is the use of yield data from previous crops to estimate future yields for a particular field. Conventionally, agronomists may estimate future yields based on point-in-time snapshots of field, such as satellite images. Alternatively, farmers may maintain coarse, field-level yield data. However, for any given field, there may be significant yield variability within the field itself. This is due to a wide variety of factors, such as soil quality, ground water, irrigation methods, fertilization methods, proximity to field boundaries, pests, and many more.

### SUMMARY

The following summary is intended to introduce the reader to various aspects of the detailed description, but not to define or delimit any invention.

In at least one broad aspect, there is provided a method for soil moisture management, the method comprising: obtaining a plurality of seasonal yield datasets for a field, each of the plurality of seasonal yield datasets containing a respective plurality of point yields corresponding to a plurality of locations of the field; normalizing the plurality of seasonal yield datasets; obtaining moisture data for the field; determining a moisture content value for each location in the field based on the normalized plurality of seasonal yield datasets and the moisture data; and generating a productivity map for the field.

In some cases, the obtaining moisture data for the field may comprise obtaining the moisture data from a sensor.

In some cases, the moisture data for the field may be obtained by one of a soil moisture probe, a proximal sensor, a remote sensor, and any other source or method.

In some cases, the sensor may be one of a precipitation monitoring probe, a soil moisture probe, and a proximal sensor.

In some cases, the sensor is one of a remote sensing satellite, an airplane, and an unmanned aerial vehicle (UAV).

In some cases, the method further comprises positioning the sensor in the field based on the normalized plurality of seasonal yield datasets.

In some cases, the generating the productivity map may further comprise, for each location of the plurality of locations: determining a yield potential of the location based on the moisture data for the field, measured soil properties, and an amount of fertilizer applied to the location.

In some cases, the method further comprises determining a nutrient requirement for each location based on the productivity map.

In some cases, the moisture data may be in a unit of measurement.

In some cases, the method further comprises converting the moisture data to predicted output of a type of crop.

In some cases, the method further comprises: determining a yield potential for a particular location in the field corresponding to a sensor, proximal sensing, satellites, and UAV; and applying forecasting regression to the yield potential for the particular location to determine the yield potential.

In some cases, the method further comprises determining the type of crop in the field for a current season and the type of crop associated with the plurality of seasonal yield datasets.

In some cases, the type of crop may be at least one of wheat, canola, barley, oats, and peas, corn, cotton, or soybeans and wherein a water use efficiency is different for different types of crop.

In some cases, the plurality of seasonal yield datasets may comprise data for at least 3 seasons.

In some cases, the method further comprises: obtaining a multispectral image collected from a satellite, airplane, or UAV of the field; identifying at least one location in the field with a selected yield potential that exceeds a predetermined threshold; and determining nutrients to be applied to each location in the field.

In some cases, the method further comprises applying the nutrients to each location in the field.

In some cases, the moisture data may be aggregate data for the field.

In another broad aspect, there is provided a system for moisture management, the system comprising: a memory storing at least one seasonal yield dataset for a field, containing a plurality of point yields corresponding to a plurality of locations in a field; and a processor, the processor configured to carry out any of the methods described herein.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic block diagram of an exemplary system for moisture management in accordance with at least some embodiments;

FIG. 2 is a block diagram of a computer in accordance with at least some embodiments;

FIG. 3 is a flowchart diagram of an exemplary method for moisture management for execution by the system of FIG. 1;

FIG. 4 is a scatter plot trend generated as part of the method of FIG. 3;

FIG. 5 is a flowchart diagram of additional steps of the exemplary method of FIG. 3;

FIG. 6A is a diagram of an example productivity map generated by the system of FIG. 1; and

FIG. 6B is a diagram of another example productivity map generated by the system of FIG. 1.

### DETAILED DESCRIPTION

Estimation of yields is used not only to estimate output for a given crop. In particular, yield estimation can be used to determine the amount of seed and fertilizer that should be applied to obtain an achievable and desired target yield for a field. However, given that a yield varies from point to point even within a field, the application of fertilizer can be optimized to apply more densely in portions of a field—also known as zones—that consistently show high yield and, conversely, more sparsely in other zones that consistently show low yield.

Estimation of nutrient content in fields is an important aspect of farm management, which is dependent on a number of factors including, but not limited to, the application of nutrients such as nitrogen, phosphorus, potassium, and sulfur, and the type of crop or crops grown in the field, such as wheat (e.g., Canada Prairie Spring Wheat), canola, barley and similar. Depending on the nutrients applied and the crops grown, which may differ from zone to zone in the field, the depletion of nutrients in the field varies.

Knowledge of moisture content in fields is another important aspect of farm management. Knowing how much moisture is in a field, coupled with knowledge of the distribution of nutrients in the field, it is possible to inform on the yield potential and quality of crops in the field. As moisture in the field impacts the yield and quality of the crop, it may be desirable to monitor the levels of moisture in the field to inform suitable responses for field management as to the moisture-based crop yield potential.

The described embodiments generally provide for reliable estimation of moisture-based crop yield potential for any field.

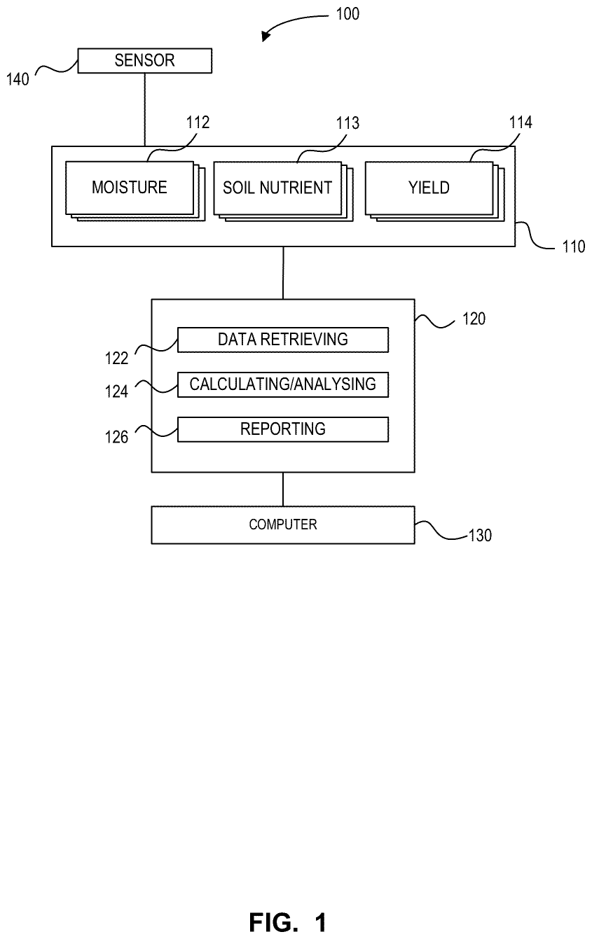

Referring now to FIG. 1, there is illustrated a schematic block diagram of a moisture management system in accordance with at least some embodiments.

Example system 100 for moisture management includes a database 110, a server 120, an end node computer 130, and a sensor 140. The database 110 contains datasets on moisture information 112, soil nutrient information 113, and crop yield information 114, for the field. The moisture information 112 is collected from the sensor 140 and includes moisture levels in the field which may be measured in real-time. The moisture information 112 may also include historic weather data.

The soil nutrient information 113 includes crop uptake and removal rates of nutrients applied to the soil in a field, pertaining to nutrients such as nitrogen, phosphorus, potassium, and sulfur, as historically applied. The soil nutrient information 113 may also include nutrient-based productivity maps for the field.

The field may be divided into a plurality of different zones, for example at a size of 1 foot by 1 foot or larger. Each zone may be identified by a grid reference or grid point, latitude and longitude, or a polygon pattern. Each zone may be a polygon shape. The crop yield information 114 includes the crop yield and the type of crop or crops grown in each zone in the field. The moisture information 112, the soil nutrient information 113 and the crop yield information 114 may correspond to several seasons or years. This provides information on yield trends and nutrient based productivity trends over the period of time for which there is data. The crops grown may be any commercially grown crop such as, for example, wheat, canola, barley, oats, and peas or similar. Different types of crops have different water needs and different water use efficiencies.

There are a number of different approaches for determining the moisture level in the field. One approach is to estimate the level of moisture in the field without the use of equipment such as the sensor 140. Another approach is to gather moisture with a field-scale rain gauge or monitor, i.e., for an entire field. Lastly, a probe or sensor such as sensor 140 placed in the field can accurately measure the local moisture level within a certain distance of the sensor. The information collected may be used in conjunction with data gathered from a weather station.

The sensor 140 may be a precipitation monitoring probe or a soil moisture probe. In some cases, the sensor 140 may be a proximal sensor or a remote sensing satellite, airplane, or unmanned aerial vehicle (UAV). If the sensor 140 is a precipitation monitoring probe or a soil moisture probe, the position of the probe in the field should be in a location most representative of the field as a whole. This ensures that the moisture information 112 collected by the sensor 140 relates to the field average. The sensor 140 measures the moisture level in the field in real-time. The measurements from the sensor 140 may be stored as moisture information 112 in the database 110. In some cases, moisture information 112 may be stored at the sensor 140 and retrieved directly by the server 120 or a user at the computer 130.

The server 120 may include a variety of different modules including a data retrieving module 122, a calculating or analysing module 124, and a reporting module 126.

The retrieving module 122 is configured to extract information for the desired period of time input by a user which, at a minimum, may be three years. The retrieving module 122 then extracts the moisture information 112, the soil nutrient information 113, and the crop yield information 114 from the database 110 for the desired period of time.

The calculating module 124 analyses the moisture information 112, the soil nutrient information 113, and the crop yield information 114 and determines a moisture-based yield potential for the field.

The reporting module 126 generates a productivity map 500 for the field based on the calculated moisture-based yield potential for the field. This can be used to inform farm management as to the current levels of moisture in each zone of the field, and therefore prompt further actions that serve to maximize yield potential based on the moisture.

A user may access the moisture information 112, the soil nutrient information 113, and crop yield information 114 via the computer 130, input the period of time the extracted data is to correspond to, and view the generated productivity map 500.

In some cases, the database 110 storing the moisture information 112, the soil nutrient information 113, and crop yield information 114 may be stored on the server 120, or on the end node computer 130. In some cases, the data retrieving module 122, calculating or analysing module 124, and reporting module 126 may also be stored on and executed by the end node computer 130.

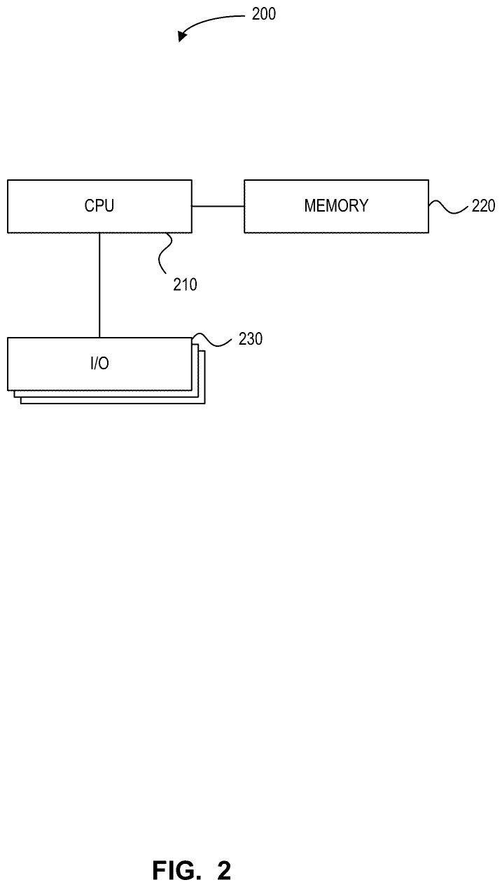

Referring now to FIG. 2, there is illustrated a simplified block diagram of a computer in accordance with at least some embodiments. Computer 200 is a generic example of a computer, such as the server 120 or computer 130 of FIG. 1. Computer 200 generally has at least one processor 210 operatively coupled to at least one memory 220, and at least one additional input/output device 230.

The at least one memory 220 includes a volatile memory that stores instructions executed or executable by processor 210, and input and output data used or generated during execution of the instructions. Memory 220 may also include non-volatile memory used to store input and/or output data along with program code containing executable instructions.

Processor 210 may transmit or receive data via a data communications interface (not shown), or may also transmit or receive data via any additional input/output device 230 as appropriate. Examples of I/O devices 230 may include interfaces for the sensor 140.

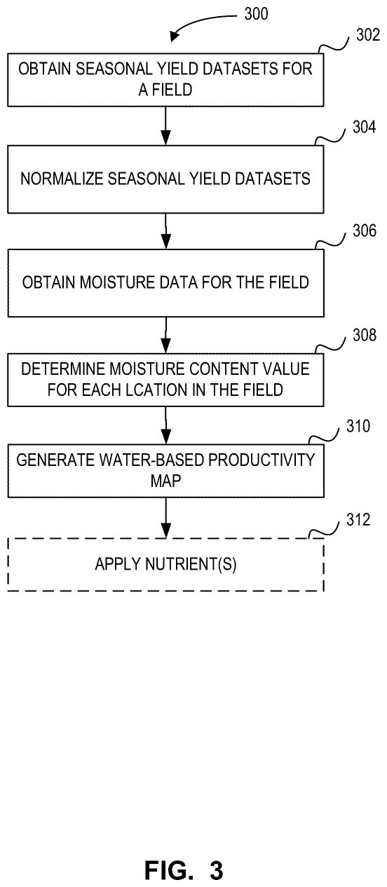

Referring now to FIG. 3 there is provided a method 300 for moisture management in a field. At step 302 the crop yield information 114 is obtained. This may be obtained, for example, by the user extracting it from the database 110 via the computer 130.

At step 304 the crop yield information 114 is normalized. This may be performed by, for example, by the calculating module 124. Every year of data from the crop yield information 114 is divided by the field average to normalize it.

At step 306 the moisture information 112 is obtained. This may be obtained, for example, by extracting it from the database 110 via the computer 130. In some cases, moisture information 112 may be collected directly from the sensor 140.

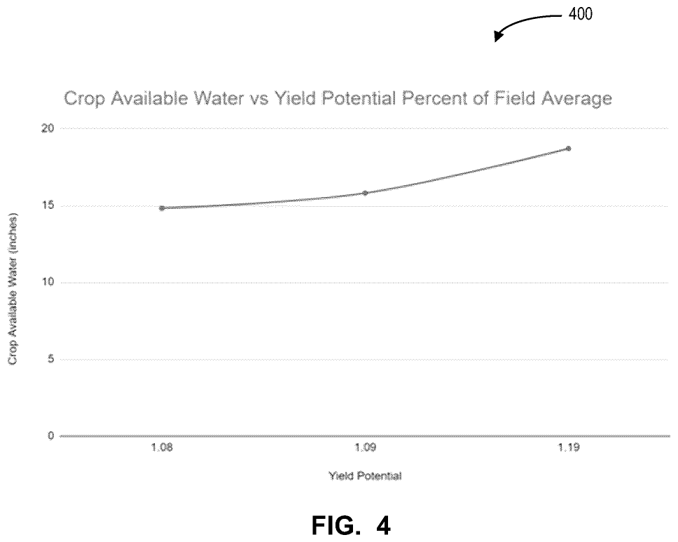

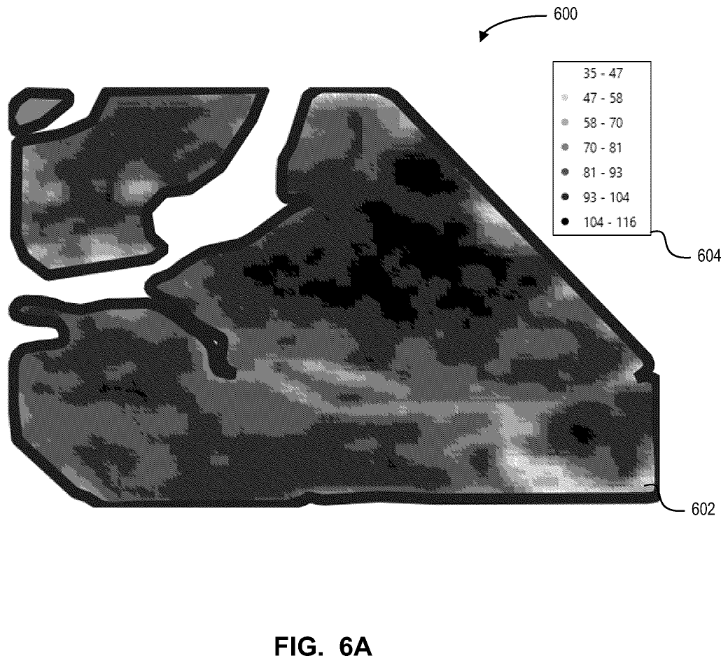

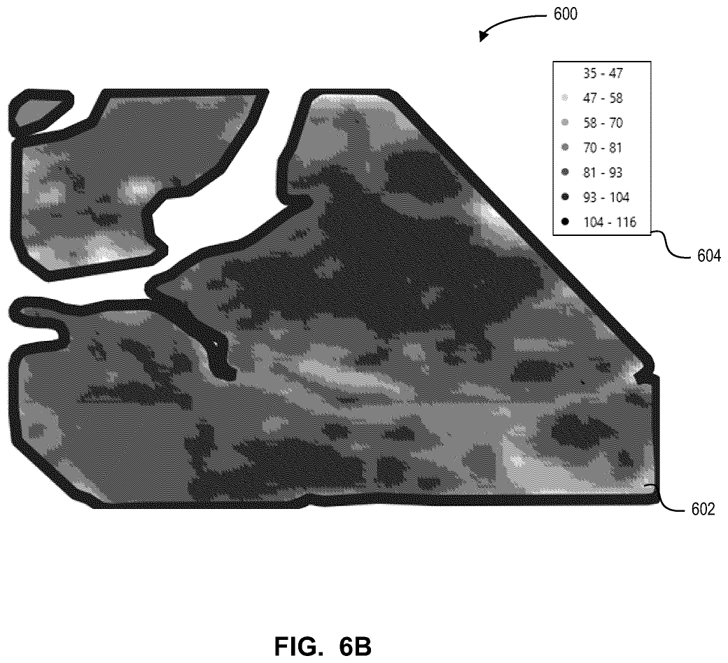

At step 308 the moisture content value for each zone in the field is determined. The crop yield information 114 is used as a proxy for the moisture level in the field, as the crops will not grow without moisture. The moisture information 112 is measured from the location in the field that is representative of the field, and therefore also relates to the field average. The calculating module 124 determines the relationship between the moisture level over a growing season and the crop yield in relation to the field average, for each zone. A scatter plot trend 400 such as that shown in FIG. 4 for each zone in the field may be generated and the relationship between moisture level and the crop yield may be linear or non-linear. The scatter plot trend 400 shows crop available water against yield potential as a percentage of the field average. As the crop available water increases, the yield potential increases. As more data is accumulated, the more accurate the trend allowing for forecasting of crop yield based on moisture levels becomes. The relationship between the moisture level and the crop yield may help to inform those responsible for field management of how much soil moisture is present in the field to maximize crop yield potential. At step 310 a moisture-based productivity map 600 such as that shown in FIG. 6A is generated by the reporting module 126.

Optionally, at step 312, nutrients are applied to the field based on the productivity map 600. For instance, a computer with global positioning system (GPS) or inertial navigation system (INS) capability may control, through an appropriate interface, a distributor (e.g., spreader or other farm implement) to apply the nutrients to the field based on the productivity map 600. Alternatively, the computer 130 may display the productivity map 600 and/or instructions for applying the nutrients.

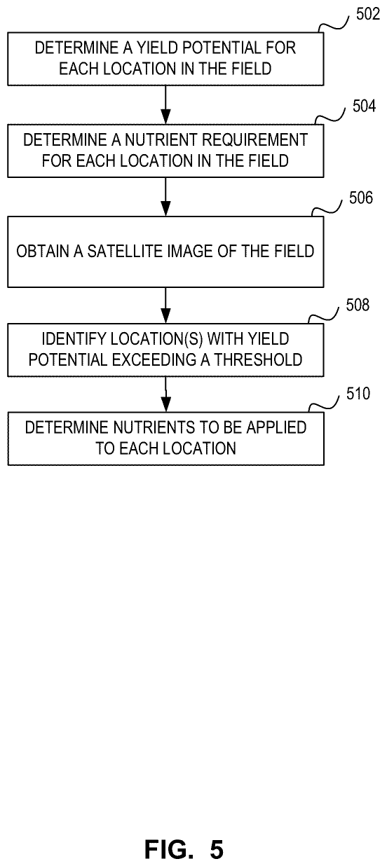

Referring now to FIG. 5 there is illustrated additional steps of the method 300. At step 502 the yield potential in each zone is determined. At this step, the soil nutrient information 113 is used to the determine the yield potential in each zone. The soil nutrient information 113 may be obtained, for example, by the user extracting it from the database 110 via the computer 130. Based on the nutrients applied to each zone in the field, which is known from the soil nutrient information 113, the calculating module 124 determines the crop yield potential for each zone.

At step 504 a nutrient requirement for each zone is determined. The calculating module 124 determines if nutrients are required based on the moisture content in the field. The moisture content information 112 may be in any unit of measurement, however for determining the nutrient requirement the moisture content information 112 is required in a predicted output of a type of crop such as, for example, bushels, kilograms, pounds per crop, or similar. The conversion may be based on a formula disclosed in, e.g., Canadian Patent Application 3014962. The conversion may also be based on a simpler approach, such as that disclosed in “Henry's Handbook of Soil and Water” by Les Henry (2010). With the crop yield potential established for the zone in which the sensor 140 is located, a linear or nonlinear forecasting regression is applied to determine the crop yield potential in the remaining zones in the field. The soil nutrient information 113 may include fertilizer application information, and the crop nutrient demands based on the moisture level can be compared to the nutrients applied at the time of seeding.

At step 506 an image is obtained through satellites, airplanes, or UAV. The image is used to determine zones in the field with a yield potential that exceeds a set threshold.

At step 508 the zones in the field with a yield potential that exceeds a set threshold are identified. By using normalized difference vegetation index (NDVI) imagery filtering on the obtained satellite image, the zones in the field with the highest yield potential as biomass are identified. Biomass has a direct correlation with yield.

At step 510, the nutrients to be applied to each zone are determined. Optionally, a nutrient application map may be generated indicating the zones requiring nutrients to maximize crop yield potential.

The moisture analytics described herein may not correlate with the approximately 140 different factors that affect plant growth including, for example, insect damage, equipment malfunctions, animal clearings, lodging, etc. Using a satellite image captures the current conditions of the field for informing the analysis.

Referring now to FIG. 6A and FIG. 6B, there is illustrated a productivity map 600. The reporting module 126 generates the productivity map 600 based on the calculated moisture levels. The field has a field boundary 602, inside which the field is then divided into the zones. Depending on the yield potential, the zone is allocated a shade on the productivity map 600 which shows the crop yield potential. The legend 604 for the productivity map 600 illustrates the shade associated with the yield potential. Both FIG. 6A and FIG. 6B illustrate a productivity map 600 for wheat on May 30, 2023. In FIG. 6A the yield potential at the sensor 140 position is 106. In FIG. 6B the yield potential at the sensor 140 position is 97. The darker the shade of the zone in the productivity map 600, the higher the yield potential in that zone. As the yield potential at the sensor 140 changes, the rest of the field is modelled accordingly to reflect those changes.

The described moisture management system and methods enable field management to determine the levels of moisture in each zone of a field, and thereby to optimize the nutrient application and yield potential of the crops. As an additional benefit, the relationship between the moisture level and the crop yield may help to inform yield management of how much soil moisture is present in the field to maximize risk management and profitability when opportunities in climate conditions are presented.

As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “affixed” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly affixed” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within engineering tolerances that would be readily appreciated by a person skilled in the art. Although embodiments have been described above with reference to the accompanying drawings, those of skill in the art will appreciate that variations and modifications may be made without departing from the scope thereof as defined by the appended claims.

What is claimed is:

1. A method for soil moisture management, the method comprising:
obtaining a plurality of seasonal yield datasets for a field, each of the plurality of seasonal yield datasets containing a respective plurality of point yields corresponding to a plurality of locations of the field;
normalizing the plurality of seasonal yield datasets;
obtaining moisture data for the field;
determining a moisture content value for each location in the field based on the normalized plurality of seasonal yield datasets and the moisture data; and
generating a productivity map for the field.

2. The method of claim 1, wherein the obtaining moisture data for the field comprises obtaining the moisture data from a sensor.

3. The method of claim 1, wherein the moisture data for the field is obtained by one of a soil moisture probe, a proximal sensor, a remote sensor, and any other source or method.

4. The method of claim 2, wherein the sensor is one of a precipitation monitoring probe, a soil moisture probe, and a proximal sensor.

5. The method of claim 2, wherein the sensor is one of a remote sensing satellite, an airplane, and an unmanned aerial vehicle (UAV).

6. The method of claim 4, further comprising:
positioning the sensor in the field based on the normalized plurality of seasonal yield datasets.

7. The method of claim 6, wherein the generating the productivity map further comprises, for each location of the plurality of locations:
determining a yield potential of the location based on the moisture data for the field, measured soil properties, and an amount of fertilizer applied to the location.

8. The method of claim 7, further comprising:
determining a nutrient requirement for each location based on the productivity map.

9. The method of claim 8, wherein the moisture data is in a unit of measurement.

10. The method of claim 9, further comprising:
converting the moisture data to predicted output of a type of crop.

11. The method of claim 3, further comprising:
determining a yield potential for a particular location in the field corresponding to a sensor, proximal sensing, satellites, and UAV; and
applying forecasting regression to the yield potential for the particular location to determine the yield potential.

12. The method of claim 9, further comprising:
determining a type of crop in the field for a current season and the type of crop associated with the plurality of seasonal yield datasets.

13. The method of claim 12, wherein the type of crop is at least one of wheat, canola, barley, oats, peas, corn, cotton, and soybeans, and wherein a water use efficiency is different for different types of crop.

14. The method of claim 1, wherein the plurality of seasonal yield datasets comprises data for at least 3 seasons.

15. The method of claim 1, further comprising:
obtaining a multispectral image collected from a satellite, airplane, or UAV of the field;
identifying at least one location in the field with a selected yield potential that exceeds a predetermined threshold; and
determining nutrients to be applied to each location in the field.

16. The method of claim 15, further comprising:
applying the nutrients to each location in the field.

17. The method of claim 1, wherein the moisture data is aggregate data for the field.

18. A system for moisture management, the system comprising:
a memory storing at least one seasonal yield dataset for a field, containing a plurality of point yields corresponding to a plurality of locations in a field; and
a processor, the processor configured to:
obtain a plurality of seasonal yield datasets for a field, each of the plurality of seasonal yield datasets containing a respective plurality of point yields corresponding to a plurality of locations of the field;
normalize the plurality of seasonal yield datasets;
obtain moisture data for the field;
determine a moisture content value for each location in the field based on the normalized plurality of seasonal yield datasets and the moisture data; and
generate a productivity map for the field.

19. A non-transitory computer readable medium storing instructions executable by a computer processor, the instructions when executed by the computer processor cause the computer processor to carry out a method of soil moisture management, the method comprising:
obtaining a plurality of seasonal yield datasets for a field, each of the plurality of seasonal yield datasets containing a respective plurality of point yields corresponding to a plurality of locations of the field;
normalizing the plurality of seasonal yield datasets;
obtaining moisture data for the field;
determining a moisture content value for each location in the field based on the normalized plurality of seasonal yield datasets and the moisture data; and
generating a productivity map for the field.
